(19) United States
(12) Patent Application Publication
(10) Pub. No.: US 2019/0037664 A1
(43) Pub. Date: Jan. 31, 2019

(54) Farming light control system, and farming light control method

(71) Applicant: Panasonic Intellectual Property Management Co., Ltd., Osaka (JP)

(72) Inventor: Bo CAO, Beijing (CN)

(21) Appl. No.: 16/047,941

(22) Filed: Jul. 27, 2018

(30) Foreign Application Priority Data
Jul. 28, 2017 (CN) 201710631782.2

(51) Int. Cl. H05B 33/08; H05B 37/02; A01K 45/00; A01K 31/18; A01G 7/04

(52) U.S. Cl. CPC H05B 33/0863; H05B 37/0245; A01G 7/045; A01K 31/18; A01K 45/00

(57) ABSTRACT

A farming light control system includes: one or more rows of lighting devices provided in a sealed farming environment; and an interface module. One or more lighting devices in each of the one or more rows of lighting devices connect to a first end of the interface module via a communication line. Each of the one or more rows of lighting devices includes the one or more lighting devices. Each of the one or more lighting devices includes a green light emitting diode (LED), a blue LED, and a white LED. A second end of the interface module connects to a control module. The control module connects to the one or more rows of lighting devices via the interface module. Each of the lighting devices has different-color LED particles. The light emission states of the lighting devices are automatically controlled by the control module.

### CROSS REFERENCE TO RELATED APPLICATION

The present application claims the benefit of Chinese Patent Application No. 2017106317822 filed Jul. 28, 2017. The entire disclosure of the above-identified application, including the specification, drawings and claims is incorporated herein by reference in its entirety.

### FIELD

The present disclosure relates to the technical field of farming, and particularly to a farming light control system and a farming light control method.

### BACKGROUND

Light irradiation is one of important environmental conditions in the process of growth of poultry. Light rays having different color temperatures cause extremely important effects on the growth of the poultry. Thus, there have been increasing user needs on light irradiation control in farming environments. Accordingly, there have been increasing needs on each of farming lighting devices, farming light control systems, and farming light control methods.

### SUMMARY

### Technical Problem

Current light control systems in farming places are a timer switch or a 0-10 V dimming control system. Thus, automatic light control and large-scale commercial use are not enabled.

In view of this, the present disclosure provides a farming light control system and a farming light control method which enable automatic light control and large-scale commercial use.

### Solution to Problem

According to an aspect of the present disclosure, a farming light control system is provided. The system includes: one or more rows of lighting devices provided in a sealed farming environment; and an interface module. One or more lighting devices in each of the one or more rows of lighting devices connect to a first end of the interface module via a communication line. Each of the one or more rows of lighting devices includes the one or more lighting devices. Each of the one or more lighting devices includes a green light emitting diode (LED), a blue LED, and a white LED. A second end of the interface module connects to a control module.

In a method that can be implemented, the interface module is an RS485 interface.

In a method that can be implemented, the control module is a programmable logic controller.

In a method that can be implemented, the system further includes: a touch panel which connects to the control module, and transmits a control signal to the control module based on a user operation.

In a method that can be implemented, the system further includes: a power supply module which connects to the touch panel and the control module, and supplies electric power to the touch panel and the control module.

In a method that can be implemented, the system further includes: a connection line terminal base which has a first end that connects to a first end of the RS485 interface and a second end that connects to the one or more rows of lighting devices via an RS485 communication line.

In a method that can be implemented, the system further includes: an alert module which connects to the control module, and issues an alert based on an alert signal transmitted by the control module.

In a method that can be implemented, the system further includes one or more elements selected from among an illuminometer, a spectrometer, a temperature sensor, and a humidity sensor; the one or more elements being provided in the sealed farming environment, connecting to the first end of the interface module via the communication line, collecting information indicating at least one of a luminance, a spectrum, a temperature, and a humidity in the sealed farming environment, and transmitting the information collected, to the control module via the interface module.

According to an aspect of the present disclosure, a farming light control method is provided. The method is applied to a control module included in the above-described farming light control system. The method includes: obtaining a mode switch signal input by a user; and controlling the one or more lighting devices so that the one or more lighting devices are switched between a first mode and a second mode based on the mode switch signal. Here, in the first mode, the green LED and the blue LED emit light, and the white LED does not emit light, and in the second mode, the white LED emits light, and the green LED and the blue LED do not emit light.

In a method that can be implemented, the first mode is a farming mode, and the second mode is a cleaning mode.

In a method that can be implemented, the method further including: controlling, based on a farming cycle, a light emission ratio between the green LED and the blue LED in each of the one or more lighting devices in the farming mode.

In a method that can be implemented, the method further includes: receiving a luminance adjustment signal input by the user; and adjusting a light emission intensity of at least one corresponding lighting device among the one or more lighting devices, based on the luminance adjustment signal.

In a method that can be implemented, the method further includes: transmitting, in the cleaning mode, a control instruction to the one or more lighting devices based on one or more addresses of the one or more lighting devices, so as to cause the one or more lighting devices to turn on sequentially.

In a method that can be implemented, the method further includes: receiving a trouble signal fed back from a lighting device included in the one or more lighting devices; and transmitting an alert signal to an alert module, based on the trouble signal.

In a method that can be implemented, the method further includes: transmitting a display control signal to a touch panel, based on the trouble signal; and causing the touch panel to display at least one of position information and trouble information of the lighting device which has a trouble.

According to other aspects of the present disclosure, a non-volatile computer-readable recording medium is provided in which computer program instructions are stored, and the above-described method is implemented when these computer program instructions are executed by a processor.

### Advantageous Effects

The control module connects to the one or more rows of lighting devices via the interface module. The respective lighting devices have different-color LED particles. The light emission states of the lighting devices are automatically controlled by the control module. The farming light control system and the farming light control method according to the present disclosure enable automatic light control and large-scale commercial use.

### BRIEF DESCRIPTION OF DRAWINGS

Hereinafter, details of a schematic embodiment are described with reference to the drawings to clarify other features and aspects of the present disclosure.

The drawings are intended to indicate the exemplary embodiment, the features, and the aspects of the present disclosure together with the Description so as to explain the principles of the present disclosure.

FIG. 1 is a diagram illustrating a farming light control system according to an embodiment of the present disclosure.

FIG. 2A is a first diagram illustrating an application scene of a farming light control system according to an embodiment of the present disclosure.

FIG. 2B is a second diagram illustrating an application scene of a farming light control system according to an embodiment of the present disclosure.

FIG. 3 is a diagram illustrating a farming light control system according to an embodiment of the present disclosure.

FIG. 4 is a diagram illustrating an interface for adjusting luminance by a touch panel according to an embodiment of the present disclosure.

### DESCRIPTION OF EMBODIMENTS

Hereinafter, exemplary embodiments, features, and aspects are described in detail with reference to the drawings. In the drawings, the same reference signs denote the same or similar functional elements. Although the respective aspects of the embodiments are illustrated in the drawings, there is no need to illustrate them according to the reduced scales unless otherwise specified.

Here, the term “exemplary” indicates “an example, an embodiment, or use for illustrative purpose”. Any of the embodiments explained as an “exemplary” one here should not be interpreted as being preferable to or more advantageous than the other embodiments.

In addition, in order to explain the present disclosure better, a number of specific details are indicated in the specific aspects below. Any person ordinarily skilled in the art should appreciate that the present disclosure can be implemented in the same manner irrespective of these specific details. Methods, means, elements, and circuits which have been well known by any person ordinarily skilled in the art are not explained in detail in some of the embodiments, in order to clarify the scope of the present disclosure.

### Embodiment 1

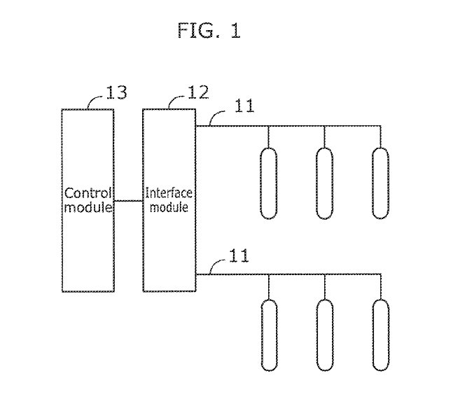

FIG. 1 is a diagram illustrating a farming light control system according to an embodiment of the present disclosure. The light control system is applicable in a sealed farming environment. The sealed farming environment refers to as an opaque farming environment. In the sealed environment, broilers such as white-feather chickens and Gushi chickens can be farmed, and other animals and plants which require shading may be farmed.

As illustrated in FIG. 1, the system includes: one or more rows of lighting devices 11 provided in the sealed farming environment; and an interface module 12.

The lighting devices 11 included in each of the one or more rows of lighting devices 11 connect to a first end of the interface module 12. Each of the one or more rows of lighting devices 11 includes the one or more lighting devices 11. Each of the one or more lighting devices 11 includes a green light emitting diode (LED), a blue LED, and a white LED. A second end of the interface module 12 connects to the control module 13.

In a method that can be implemented, the interface module 12 is an RS485 interface, and a person ordinarily skilled in the art would appreciate that the interface module 12 may be any of other serial communication interfaces such as an RS422 interface and an RS232 interface.

The control module 13 and the lighting devices can communicate with each other using the Modbus protocol. For example, the control module 13 is capable of: transmitting an instruction (for example, a query instruction, a control command, or the like) based on the address of each lighting device; referring to the address of the lighting device or controlling the light emission state, etc. of the lighting device; further receiving a message transmitted by the lighting device; and executing a corresponding operation based on a device address, a function code, etc. in the message. The operation is, for example, a trouble notification, an alert, or the like. The person ordinarily skilled in the art can define the specific details of the protocol as necessary, and thus the present disclosure is not limited thereto.

An example where the interface module 12 is an RS485 is provided. When each of the one or more rows of lighting devices 11 includes a plurality of lighting devices, a hand-shake RS485 connection can be employed for each of the lighting devices, or a direct parallel connection method can be employed. This is non-limiting examples of the present disclosure.

It is to be noted that the lighting device includes an RS485 converter circuit corresponding to the RS485 interface, and, after the lighting device receives an instruction transmitted by the control module 13, causes the RS485 converter circuit to convert the instruction into a serial port command of a microcontroller unit (MCU), thereby controlling lighting devices so that the lighting devices perform corresponding light irradiation based on the serial port command.

The system includes one or more rows of lighting devices according to a farming style or the size of a farming space. More specifically, taking white-feather chickens as an example, the system is applicable to a cage-free farming method, and also to a cage farming method.

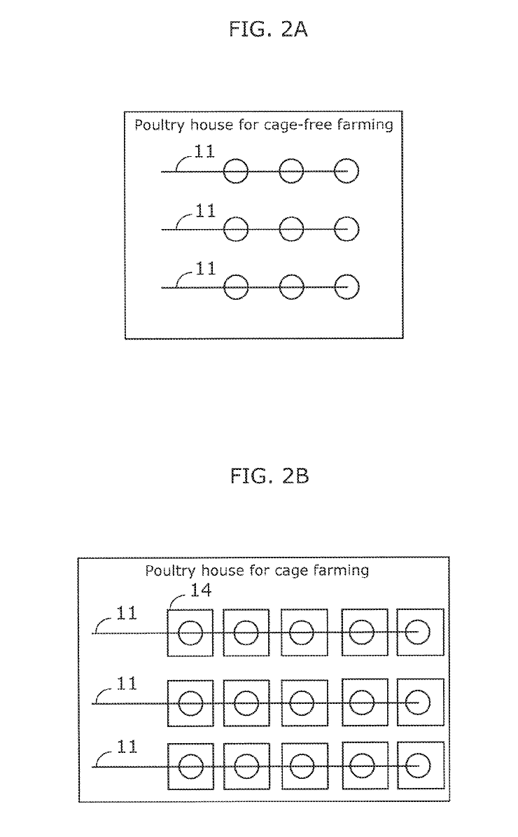

FIGS. 2A and 2B are each a diagram illustrating an application scene of a farming light control system according to an embodiment of the present disclosure.

As illustrated in FIG. 2A, when the system is applied to the cage-free farming method, the lighting devices in each row are provided on an upper part of the poultry house, for example, on the roof of the poultry house. One or more rows of lighting devices 11 can be provided in a poultry house for cage-free farming according to the size of the poultry house for cage-free farming. Furthermore, it is possible to set a suitable number of lighting devices included in each row of lighting devices in a poultry house for cage-free farming according to the size of the poultry house for cage-free farming. For example, in the cage-free farming mode, 198 lighting devices connect to the farming light control system according to the present disclosure. The present disclosure is not limited thereto.

As illustrated in FIG. 2B, when the system is applied to the cage farming method, squares in FIG. 2B indicate bird cages 14, lighting devices are provided on the roofs of the bird cages 14, one or more rows of lighting devices can be provided in each bird cage according to the size of the bird cage, it is possible to set a suitable number of lighting devices included in each row of lighting devices according to the number of bird cages. The present disclosure is not limited thereto.

At most 9504 lighting devices can be connected to the RS485 interface, in a one-cage farming method, and thus the farming light control system according to the present disclosure is applicable to a large farming environment, and to large-scale commercial use.

In a method that can be implemented, each lighting device includes a green LED, a blue LED, and a white LED. LEDs having different colors can be connected in different circuits, and LEDs having the same color can be connected in the same circuit or in different circuits. For example, all of green LEDs are connected in the same circuit, all of blue LEDs are connected in the same circuit, all of white LEDs are connected in the same circuit. In other words, the green LEDs, the blue LEDs, and the white LEDs are arranged in different circuits. In this way, it is possible to control the LEDs having different colors independently, and thus the light emission states of LEDs each having one of the colors is not affected by LEDs each having any of the other colors. In this way, the light emission states of the LEDs having different colors are adjusted according to a request for a spectrum in a farming cycle.

In a method that can be implemented, the control module 13 may be a programmable logic controller (PLC). An engineer can edit a corresponding operation instruction based on the farming cycle and store the operation instruction in the PLC, and after a program is activated, the PLC outputs an instruction that is for example a query instruction, a broad control instruction, or the like, based on the Modbus protocol, and refers to or controls the light emission states of the lighting devices. The PLC is capable of receiving a message which is fed back or transmitted by each lighting device, and obtaining position information or the like of the lighting device based on the received message.

The control module connects to one or more rows of lighting devices via an interface module. Each of the lighting devices has different-color LED particles. The light emission states of the lighting devices are automatically controlled by the control module. The farming light control system according to the present disclosure enables automatic light control and large-scale commercial use.

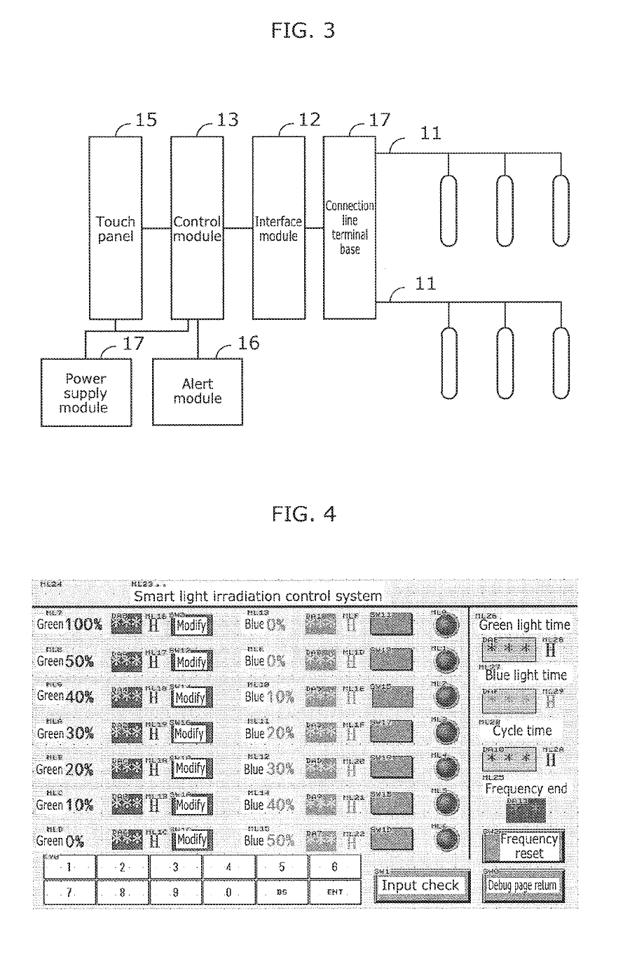

FIG. 3 is a diagram illustrating a farming light control system according to an embodiment of the present disclosure. As illustrated in FIG. 3, in a method that can be implemented: the system further includes a touch panel 15; the touch panel 15 connects to the control module 13, and a control signal is transmitted to the control module 13 based on a user operation.

Taking an example, the touch panel 15 is, for example, a liquid crystal display (LCD) touch panel, an LED touch panel, or the like. The touch panel 15 displays operation buttons (for example, Start, Pause, and Stop the farming mode, Start and Pause the cleaning mode, Adjust luminance, etc.). A user performs an operation by touching an operation button using a finger, a stylus, or the like. The touch panel 15 transmits a control signal to the control module 13 based on the user operation. An example is given. The user touches the button of Start the farming mode using a finger. The touch panel 15 detects the touch by the user, then, transmits a control signal to the control module 13. The control module 13 receives the control signal, and then transmits a control instruction to each lighting device via the interface module 12, based on the stored program, so as to control the light emission state of the lighting device.

In a method that can be implemented, the control module 13 is further capable of obtaining a mode switch signal input by the user and causing each lighting device to switch between the first mode and the second mode based on the mode switch signal. Here, the green LEDs and the blue LEDs emit light and the white LEDs do not emit light in the first mode, and the white LEDs emit light and the green LEDs and the blue LEDs do not emit light in the second mode.

Here, the first mode is the farming mode, and the second mode is the cleaning mode. Although the farming mode is a broiler farming mode, the farming mode may be a farming mode for farming other birds, plants, etc., and the present disclosure is not limited thereto.

The user touches a switch mode button using a finger, and the touch panel 15 detects a user touch, and then a mode switch signal is transmitted to the control module 13. The control module 13 receives the mode switch signal, and then a control instruction is transmitted to each lighting device via the interface module 12, based on the mode switch signal, and a switch to a corresponding mode is made by controlling the lighting device. For example, at an intermediate interval between two neighbouring farming cycles or in a process of a farming cycle, a poultry house needs to be disinfected or cleaned hygienically. Light irradiation for continuously using a farming mode is not suitable as a light irradiation mode at this time. A user touches the button for starting the cleaning mode. The touch panel 15 transmits a mode switch signal to the control module 13. The control module 13 transmits a control instruction to the lighting device, and switches a current lighting mode to the cleaning mode. In the cleaning mode, the white LEDs emit light, and the green LEDs and the blue LEDs do not emit light. At this time, white light irradiation in general lighting is used in a farming environment, and the light irradiation conditions are suitable for cleaning performed by a farming worker in the poultry house.

In this way, different needs for light irradiation in different operation modes are provided and different user experiences are also provided by adjusting the operation modes of the lighting devices to different operation modes.

In a method that can be implemented, the control module 13 further controls the light emission ratio between the green LEDs and the blue LEDs in each lighting device, based on the farming cycle in the farming mode.

More specifically, taking the broiler farming as an example, not only the farming cycles for different breeds of broilers but also requests for light irradiation conditions in different stages of one farming cycle (such as a brooding period, a rearing period, a fattening period) are different. For example, requests for spectra in different stages, for example, the ratios between green light and blue light or light irradiation intensities are different. Accordingly, taking the PLC as an example, the engineers can: edit a corresponding operation instruction based on the farming cycle, store the instruction in the PLC; after a program is activated, outputs a broad control instruction, controls the light emission states (for example, spectra, intensities, etc.) in different stages, emits light having different spectra in different periods of growth of the broilers, and implement automatic light control. On the precondition that the growth cycle is unchanged, objects of increasing the weights of growing-up broilers and increasing the growth rates are achieved.

In a method that can be implemented, the control module 13 further transmits a control instruction to the lighting devices based on the addresses of the lighting devices when switching to the cleaning mode, so as to turn on the lighting devices sequentially.

As described above, the user touches the button of Start cleaning mode, the touch panel 15 transmits the mode switch signal to the control module 13. The control module 13 in the system transmits a control instruction to the respective lighting devices in time division and/or space division, based on the MAC addresses of the lighting devices, and so as to turn on the lighting devices sequentially (or in a divided manner). In this way, prevention of current overload trip at the moment when each lighting device turns on is ensured, and safety and stable operation of a power supply line at the time when the farming control system starts is ensured.

In a method that can be implemented, furthermore, the control module 13 receives a luminance adjustment signal input by a user, and adjusts a light emission intensity of the corresponding lighting device based on the luminance adjustment signal.

Here, the luminance adjustment signal includes a lighting device identifier and adjusted luminance information, etc. The lighting device identifier may be any identifier for distinguishing a lighting device from the others, and for example may be one or more numerals, one or more characters, or an array of any of the one or more numerals and any of the one or more characters.

On the preconditions that broilers at each growth period are irradiated with light having a different irradiation intensity and that the growth cycle is unchanged, objects of increasing the weights of growing-up broilers and increasing the growth rates are achieved.

FIG. 4 is a diagram illustrating an interface for adjusting luminance using a touch panel according to an embodiment of the present disclosure. As illustrated in FIG. 4, the touch panel 15 can display adjustment buttons corresponding to the respective lighting devices, can further display the lighting device identifiers (each indicating, for example, a place in a row), and the user selects each lighting device whose luminance is to be adjusted and inputs the adjusted luminance information. The touch panel 15 transmits a luminance adjustment signal which is input by the user to the control module 13 based on the user operation. The control module 13 receives the luminance adjustment signal input by the user, and then identifies address information of the corresponding lighting device based on the luminance adjustment signal, transmits a control instruction to the lighting device, and causes the lighting device to change the light intensity.

As illustrated in FIG. 3, in a method that can be implemented: the system further includes an alert module 16; and the alert module 16 connects to the control module 13, and issues an alert based on an alert signal which is transmitted by the control module 13.

In a method that can be implemented, the alert module 16 is a device capable of issuing an alert signal which is a sound or light signal, and may be, for example, a buzzer, a speaker, a flash, or the like.

When the lighting device has a trouble (for example, a stroboscopic phenomenon, non-lighting), the lighting device transmits a message (alert signal) to the control module 13 via the interface module 12); taking the RS485 interface module as an example, the lighting device transmits a message to the control module based on the Modbus protocol; and the message includes position information and trouble information of the lighting device. The control module 13 receives the message transmitted by the lighting device, obtains the position information and the trouble information based on a device address, a device code, etc. in the message, transmits an alert signal to the alert module 16 based on the trouble information. After receiving the alert signal, the alert module 16 is capable of issuing an alert to the farming worker, for example, by issuing a buzzer sound.

In this way, when the lighting device has the trouble, the alert is issued to the farming worker so that the farming worker performs a test and a repair as necessary to reduce a farming death rate, thereby reducing an economical loss of the farming worker.

In a method that can be implemented, furthermore, the control module 13 transmits a display control signal to the touch panel 15 based on the trouble signal, and causes the touch panel 15 to display at least one of the position information and the trouble information of the lighting device having the trouble.

As described above, when the lighting device has the trouble (for example, a stroboscopic phenomenon, non-lighting), the lighting device transmits a message (alert signal) to the control module 13 via the interface module 12); and the message includes the position information and the trouble information of the lighting device. The control module 13 receives the message transmitted by the lighting device, obtains the position information and the trouble information of the lighting device based on the device address and the device code in the message, transmits the display control signal to the touch panel 15, and causes the touch panel 15 to display the position information, the trouble information, etc. of the lighting device having the trouble.

As illustrated in FIG. 3, in a method that can be implemented: the system further includes a power supply module 17; and the power supply module 17 connects to the touch panel 15 and the control module 13, and supplies electric power to the touch panel 15 and the control module 13.

The power supply module 17 may be an AC-DC converter, converts an alternating current into an appropriate voltage signal, and outputs the signal to the control module and the touch screen. A power supply of another type is possible, and the present disclosure is not limited thereto.

As illustrated in FIG. 3, in a method that can be implemented: the system further includes a connection line terminal base 18; the connection line terminal base 18 has a first end connected to the first end of the RS485 interface and a second end connected to one or more rows of lighting devices 11 via the RS485 communication line. The connection line terminal base 18 is useful in line connection, and particularly when the number of the one or more rows of lighting devices to be controlled is comparatively large.

In a method that can be implemented: the system further includes one or more elements selected from among an illuminometer, a spectrometer, a temperature sensor, and a humidity sensor. The one or more elements are provided in the sealed farming environment, connect to the first end of the interface module 12 via the communication line, collect information indicating at least one of a luminance, a spectrum, a temperature, and a humidity in the sealed farming environment, and transmit the information collected, to the control module 13 via the interface module 12.

Taking the one or more illuminometers as an example, the one or more illuminometers are provided in a sealed farming environment. For example, each of the one or more illuminometers is provided at a position closer to the floor of a poultry house for cage-free farming, or in a bird cage 14 in a poultry house for cage farming, and useful for adjusting the collected illuminance information to illuminance which is suitable for the poultry. In the farming process, each of the one or more illuminometers collects the illuminance in the bird cage 14, and transmits a message to the control module 13 via a communication line and the interface module 12. The control module 13 obtains the illuminance detected by the illuminometer based on the received message, compares the detected illuminance with an illuminance that is currently required in the farming cycle. When the difference between the both exceeds a certain limit value, the control module 13 transmits a luminance adjustment instruction to the lighting device to adjust the luminance of light to be emitted by the lighting device. At the time of device debugging, the control module 13 adjusts a control instruction of a program based on the result of the detection fed back by the illuminometer, and it is ensured that an actual illuminance satisfies the requirement for farming. This saves time and cost for manual adjustment, and facilitates the use of the system. For the convenience of reference and comparison, the control module 13 is capable of recording reference illumination information in each stage of the farming cycle.

When a plurality of illuminometers are provided, the control module 13 is also capable of adjusting the light emission states of the lighting devices around the illuminometers based on the position information of the illuminometers. For example, the control module 13 obtains the position information of the illuminometers based on received messages, and transmits a luminance adjustment instruction to the lighting devices positioned around the illuminometers with reference to the MAC addresses of the surrounding lighting devices based on the position information so as to control the luminance of light to be emitted by some of the lighting devices.

Likewise, it is also possible to adjust information such as spectra of light emitted by the lighting devices in the farming environment, an ambient temperature, a humidity, or the like, provided by a spectrometer, a temperature sensor, or a humidity sensor. As for specific adjustment methods, the descriptions regarding the illuminometers should be referred to, and the descriptions are not repeated.

The present disclosure encompasses a system, a method, and/or a computer program product. The computer program product includes a computer-readable recording medium. Computer-readable program instructions may be stored thereon for causing a processor to execute each of the aspects of the present disclosure.

The computer-readable recording medium may be a tangible device which stores and records instructions to be used by an instruction executing device. The computer-readable recording medium is not limited thereto, and for example, may be an electric storage device, a magnetic storage device, an optical storage device, an electromagnet storage device, a semiconductor storage device, or an arbitrary combination of these devices. More specific examples (an inexhaustive list) of computer-readable recording media include a portable computer disc, a hard disc, a random access memory (RAM), a read-only memory (ROM), an erasable program read-only memory (EPROM or flash memory), a static random access memory (SRAM), a portable compact disc ROM (CD-ROM), a digital multi-functional disc (DVD), a memory stick, a floppy disc, and a mechanical coding device. For example, the computer-readable recording media may be a card with holes or a structure with protrusions in grooves storing instructions thereon, and an arbitrary combination of the above-described recording media. The computer-readable recording media used here are not interpreted as instantaneous signals themselves (for example, radio waves or other transmissive electromagnetic waves, electromagnetic waves that are transmitted by waves or via other transmission media (for example, optical pulses via an optical fiber cable), or electric signals transmitted via electric wires).

The computer-readable program instructions described here are downloaded to each computer/processor from a computer-readable recording medium, or downloaded to an external computer or an external storage device via one or more networks that are the Internet, a local area network, a broad area network, and/or a wireless internet. The networks include a copper transmission cable, an optical fiber transmission, a wireless transmission, a router, a firewall, an exchanger, a gateway computer and/or an edge server. The network interface card or the network interface in each computer/processor receives computer-readable program instructions from the network, transmits the computer-readable program instructions, and stores them onto the computer-readable recording medium in the computer/processor.

The computer program instructions for executing operations in the present disclosure may be assembler instructions, instruction set architecture (ISA) instructions, device instructions, device-related instructions, micro codes, firmware instructions, state-installation data, or source codes or object codes which are edited by an arbitrary combination of one or more kinds of programming languages. The programming languages include object-oriented programming languages (for example, Smalltalk, C++, etc. and normal procedural programming languages) such as “C” language or similar programming languages. All or part of the computer-readable program instructions may be executed on a user's computer, or may be executed as an independent package. Part of the computer-readable program instructions may be executed on a user's computer, and the other part may be executed on a remote computer. Alternatively, all of the computer-readable program instructions may be executed on a remote computer or a server. In the case related to a remote computer, the remote computer connects to a user computer via an arbitrary kind of network (including a local area network (LAN)) or a broad area network (WAN)), or connects to an external computer (for example, via the Internet using an internet service provider). In an embodiment, an electronic circuit (for example, a programmable logic circuit, a field programmable gate array (FPGA), or a programmable logic array (PLA)) is customized using status information of the computer-readable program instructions so that the electronic circuit can execute the computer-readable program instructions. In this way, each of the aspects of the present disclosure is implemented.

Here, the respective aspects of the present disclosure are explained with reference to the flowcharts of the method and/or block diagrams of the device (system) and the computer program product according to embodiments of the present disclosure. Any combination of the blocks of the flowchart(s) and/or the block diagram(s) and the blocks of the flowchart(s) and/or the block diagram(s) should be appreciated as being executed by computer-readable program instructions.

A device can be generated by supplying these computer-readable program instructions to a general computer, an exclusive computer, or the processor in another programmable data processing device. The device which performs functions/operations defined in the one or more blocks of the flowchart(s) and/or the block diagram(s) is generated by means of these instructions being executed by the computer or the processor in the other programmable data processing device.

These computer-readable program instructions are stored in a computer-readable storage medium, and these instructions cause the computer, the programmable data processing device and/or the other device to operate in a particular method. In this way, the computer-readable recording medium storing the instructions includes one product, and it includes instructions for implementing the respective aspects of the functions/operations defined in the one or more blocks of the flowchart(s) and/or the block diagram(s).

The computer-readable program instructions are loaded onto the computer, the other programmable data processing device, or the other device. A series of operation steps is executed on the computer, the other programmable data processing device, or the other device. Processes performed by the computer are generated, thereby causing the functions/operations defined in the one or more blocks of the flowchart(s) and the block(s) to be executed according to the instructions executed on the computer, the other programmable data processing device, or the other device.

The flowchart(s) and block diagram(s) indicate possible architectures, functions, and operations of the system, the method, and the computer program product according to a plurality of embodiments of the present disclosure. In this point: each of the blocks in the flowchart(s) or block diagram(s) indicates a module, a program segment, or part of instructions; and the module, the program segment, or the part of instructions includes instructions that can be executed for implementing one or more predetermined logic functions. In an alternative implementation, functions indicated in some of the blocks in any one of the diagrams may be generated in the order different from the order indicated in the diagram. For example, two consequent blocks may be executed substantially in almost parallel, or may be executed in the opposite order. This is determined by related functions. It is to be noted that any combination of the blocks of the flowchart(s) and/or the block diagram(s) and the blocks of the flowchart(s) and/or the block diagram(s) is executed by an exclusive hardware system for executing the predetermined functions or operations, or executed by a combination of an exclusive hardware and computer instructions.

Although the respective embodiments of the present disclosure have been described above, the descriptions thereof are examples, not inexhaustive, and not limited to the disclosed embodiments. A number of modifications and variations are obvious to any person ordinarily skilled in the art within the scope and sprit of the respective embodiments. The terms used in the text herein are selected to optimally explain technical improvement in actual applications or in the market, or to allow any person ordinarily skilled in the art to appreciate the respective embodiments disclosed in the text.

1. A farming light control system, comprising:
one or more rows of lighting devices provided in a sealed farming environment; and
an interface module,
wherein one or more lighting devices in each of the one or more rows of lighting devices connect to a first end of the interface module via a communication line, each of the one or more rows of lighting devices including the one or more lighting devices, each of the one or more lighting devices including a green light emitting diode (LED), a blue LED, and a white LED, and
a second end of the interface module connects to a control module.

2. The farming light control system according to claim 1,
wherein the interface module is an RS485 interface.

3. The farming light control system according to claim 1,
wherein the control module is a programmable logic controller.

4. The farming light control system according to claim 3, further comprising:
a touch panel which connects to the control module, and transmits a control signal to the control module based on a user operation.

5. The farming light control system according to claim 4, further comprising:
a power supply module which connects to the touch panel and the control module, and supplies electric power to the touch panel and the control module.

6. The farming light control system according to claim 2, further comprising:
a connection line terminal base which has a first end that connects to a first end of the RS485 interface and a second end that connects to the one or more rows of lighting devices via an RS485 communication line.

7. The farming light control system according to claim 1, further comprising:
an alert module which connects to the control module, and issues an alert based on an alert signal transmitted by the control module.

8. The farming light control system according to claim 1, further comprising:
one or more elements selected from among an illuminometer, a spectrometer, a temperature sensor, and a humidity sensor; the one or more elements being provided in the sealed farming environment, connecting to the first end of the interface module via the communication line, collecting information indicating at least one of a luminance, a spectrum, a temperature, and a humidity in the sealed farming environment, and transmitting the information collected, to the control module via the interface module.

9. A farming light control method which is applied to the control module in the farming light control system according to claim 1, the method comprising:
obtaining a mode switch signal input by a user; and
controlling the one or more lighting devices so that the one or more lighting devices are switched between a first mode and a second mode based on the mode switch signal,
wherein, in the first mode, the white LED does not emit light, and the green LED and the blue LED emit light, and
in the second mode, the green LED and the blue LED do not emit light, and the white LED emits light.

10. The farming light control method according to claim 9,
wherein the first mode is a farming mode, and the second mode is a cleaning mode.

11. The farming light control method according to claim 10,
wherein, in the farming mode, a light emission ratio between the green LED and the blue LED in each of the one or more lighting devices is controlled based on a farming cycle.

12. The farming light control method according to claim 9, further comprising:
receiving a luminance adjustment signal input by the user; and
adjusting a light emission intensity of at least one corresponding lighting device among the one or more lighting devices, based on the luminance adjustment signal.

13. The farming light control method according to claim 10, further comprising:
transmitting, in the cleaning mode, a control instruction to the one or more lighting devices based on one or more addresses of the one or more lighting devices, so as to cause the one or more lighting devices to turn on sequentially.

14. The farming light control method according to claim 9, further comprising:
receiving a trouble signal fed back from a lighting device included in the one or more lighting devices; and
transmitting an alert signal to an alert module, based on the trouble signal.

15. The farming light control method according to claim 14, further comprising:
transmitting a display control signal to a touch panel, based on the trouble signal; and
causing the touch panel to display at least one of position information and trouble information of the lighting device which has a trouble.

16. A non-volatile computer-readable recording medium storing a computer program instruction which, when executed by a processor, enables the farming light control method according to claim 10.
